(19) United States
(12) Patent Application Publication
(10) Pub. No.: US 2014/0185545 A1
(43) Pub. Date: Jul. 3, 2014

(54) Method for Configuring a User Equipment

(71) Applicant: Nokia Siemens Networks Oy, Espoo (FI)

(72) Inventors: Stanislaw Strzyz, Poznan (PL); Frank Frederiksen, Klarup (DK); Klaus Ingermann Pedersen, Aalborg (DK)

(73) Assignee: Nokia Siemens Networks Oy, Espoo (FI)

(21) Appl. No.: 14/125,106

(22) PCT Filed: Jun. 10, 2011
(86) PCT No.: PCT/EP2011/059687

§ 371 Date: Feb. 14, 2014

(51) Int. Cl. H04W 72/02

(52) U.S. Cl. CPC H04W 72/02
USPC 370/329

(57) ABSTRACT

It is described a method for configuring a user equipment within a cell of a cellular network. The cell includes a base station, and the user equipment is served by the base station. Signals between the base station and the user equipment are transmittable using a communication channel, wherein the communication channel is divided into subframes. A part of the subframes being allocated to uplink transmission is unscheduled by the base station due to a predefined muting pattern. The method includes sending from the base station to the user equipment a signal including information about the muting pattern, and configuring the user equipment to transmit at unscheduled subframes based on the muting pattern.

### FIELD OF INVENTION

The present invention relates to the field of cellular networks and in particular to cellular networks using a muting pattern.

### ART BACKGROUND

In current 3GPP specifications, time domain (TDM) enhanced inter-cell interference coordination (eICI) has been introduced. The eICIC concept is introducing coordination mechanisms such that it is possible to reduce the interference from an aggressor cell to a victim cell. The TDM eICIC is mainly designed to address downlink interference challenges, but also has some undesirable effects on uplink performance.

Two main use cases were used during the standardization work, the Pico-Macro case and the Macro-Femto case. In the Pico-Macro case, the coverage area of the pico cell is extended by the macro cell muting given subframes in the time domain, thereby causing a heavy reduction of the interference seen by the user equipments (UEs) that are connected to the pico node—especially for the UEs that are close to the cell edge of the pico coverage area. In the Macro-Femto case, the aggressor cell is the CSG HeNB (very small base station with closed subscriber group (CSG) for limited access), which will also apply some time domain muting patterns to allow for UEs within the coverage area of the CSG HeNB to be able to “hear” the macro cell. In this way, all macro connected UEs can potentially still be connected to the macro node and avoid experiencing a so-called coverage hole.

Normally, the aggressor cell will apply muting on specific subframes in the time domain so as to reduce the interference detected by users in the victim cell. When applying downlink TDM muting patterns, only essential information (such as information vital to the operation of the system, for instance reference symbols, synchronization sequences, broadcast channels, etc) is conveyed from the aggressor cell. This means that the aggressor cell is not allowed to transmit any information that is related to the downlink direction. From a downlink scheduling point of view, this may be a sensible configuration, as the downlink data channel physical downlink shared channel (PDSCH) is transmitted within the same transmit time interval (TTI) as the downlink control channel physical downlink control channel (PDCCH).

As uplink data also need scheduling through the PDCCH (as all scheduling decisions—also for the uplink direction are taken by the base station), there will be a loss of uplink capacity when applying TDM eICIC. As there is a fixed timing relationship between the PDCCH transmitted in the downlink and the uplink transmission on the physical uplink shared channel (PUSCH), the introduction of a muting pattern for certain subframes may cause a loss in capacity in both downlink as well as on the uplink capacity (on the cell using muting).

Therefore, there may be a need for an improved system and method, wherein the loss in capacity in the uplink may be reduced.

### SUMMARY OF THE INVENTION

This need may be met by the subject matter according to the independent claims. Advantageous embodiments of the present invention are described by the dependent claims.

According to a first aspect of the invention there is provided a method for configuring a user equipment within a cell of a cellular network, wherein the cell comprises a base station, and wherein the user equipment is served by the base station, wherein signals between the base station and the user equipment are transmittable using a communication channel, wherein the communication channel is divided into subframes, and wherein a part of the subframes being allocated to uplink transmission is unscheduled by the base station due to a predefined muting pattern. The method comprises sending from the base station to the user equipment a signal comprising information about the muting pattern, and configuring the user equipment to transmit at unscheduled subframes based on the muting pattern.

This aspect of the invention is based on the idea to use a user equipment (UE) operational mode, which allows for uplink (UL) transmission in the resources that would otherwise not be schedulable due to the lack of PDCCH (i.e. uplink scheduling grants), which in turn is missing due to muted subframes.

The problem of applying downlink TDM muting patterns is that only essential information is conveyed from the aggressor cell. This means that the aggressor cell is not allowed to transmit any information that is related to the downlink direction. Seen from a downlink scheduling point of view, this is a sensible configuration, as the downlink data channel (physical downlink shared channel—PDSCH) ia transmitted within the same transmit time interval (TTI) as the downlink control channel (physical downlink control channel—PDCCH). However, as uplink data also need scheduling through the PDCCH (as all scheduling decisions—also for the uplink direction are taken by the base station), there will be a loss of uplink capacity when applying TDM eICIC. There is a fixed timing relationship between the PDCCH transmitted in the downlink and the uplink transmission on the physical uplink shared channel (PUSCH). With this in mind, it is obvious that introducing a muting pattern with for instance 30% of the subframes muted might cause a 30% loss of the downlink capacity as well as a 30% loss of the uplink capacity (on the cell using muting).

According to this embodiment, at least a part of the lost UL capacity might be re-captured by introducing an enhanced mechanism for allowing continuous uplink transmission also in the presence of downlink muting. The UE might be configured to transmit data only in unscheduled subframes. The UE may be put into an operational mode, which allows for UL transmission in the resources that would otherwise not be schedulable due to the lack of PDCCH (i.e. uplink scheduling grants), which in turn is missing due to the muted subframes.

According to an embodiment of the invention, configuring the user equipment comprises sending from the base station to the user equipment a signal comprising information about an allocation of resources within the unscheduled subframes.

By using such a signal, the UE may know which resources it is allowed to use in subframes where serving cell is not able to send corresponding uplink scheduling grants on PDCCH due to muted subframes. Such a signal may be send for instance during the establishment of the connection between UE and base station.

According to a further embodiment of the invention, the information about the allocation of resources comprises information about the frequency and/or time domain allocation.

Here, the information may be related to the subframes, which are unscheduled.

According to a further embodiment of the invention, sending from the base station to the user equipment a signal comprising information about the muting pattern is based on the radio resource control protocol or the medium access control protocol.

The downlink TDM muting patterns may be indicated to the UEs through dedicated signaling, where the UE is told which subframes in the time domain are to be used for which purpose. One possibility to introduce muting patterns may be almost blank subframes (ABS), where the aggressor will only transmit limited information (such as information vital to the operation of the system—these include reference symbols, synchronization sequences, broadcast channels, etc). For handling the knowledge of which subframes are ABS and which are not, there may be used signaling that directly informs the UE of which subframes are ABS, and which are not. Such signaling could be radio resource control (RRC) or medium access control (MAC). ABS in this context may refer to any kind of muting applied to the downlink channel.

According to a further embodiment of the invention, configuring the user equipment comprises configuring the user equipment to transmit at unscheduled subframes for a predefined number of subframes and/or during a predefined time period.

For example, a downlink control information (DCI) format may be used, which could allow for “uplink scheduling ahead”, meaning that there would be some bits in the control information for the uplink allocations that also indicate the time relative to the normal UL grant to use for uplink transmission. Each UL grant may take up one allocation resource on the PDCCH. One may also use a flag, indicating a “UL sticky allocation”, which may indicate that when set, the UE should continue transmitting on the resources either for a preconfigured (over RRC) number of subframes, or over a period derived from the muting pattern configuration/detection.

Also a combination of the above may be used, where a DCI format with a few additional bits (or remapping of current bits) may have the option to also indicate the duration of allocation. As an example, a two-bit additional DCI field would have the option of indicating four states, which could be: (0) allocation for current UL subframe, (1) allocation valid for current subframe and lasting 1 additional subframe, (2) similar to state 1, but lasting for 2 subframes, and (3) similar to state 1, but lasting for 3 subframes. With such a configuration, the UE would not need to have knowledge of the muting patterns used by the aggressor node, as the duration of the extension is given in the grant.

According to a further embodiment of the invention, the method further comprises determining whether the user equipment intends to send data during the unscheduled subframes, and, if the user equipment intends to send no data, sending from the user equipment to the base station a signal comprising the information that the user equipment intends to send no data in the unscheduled subframes.

If the UE does not have any data to send during the unscheduled subframes, which corresponds to an UL extension phase, it may revert to normal (for instance 3GPP release 8) behavior and transmit an empty buffer status report and jump out of the mode, in which unscheduled subframes are used for transmission.

According to a further embodiment of the invention, configuring the user equipment comprises performing channel state information measurements by the user equipment, and configuring the user equipment is based on the channel state information measurements and the muting pattern to transmit at unscheduled subframes.

With the introduction of TDM eICIC, a double set of CSI measurement patterns was introduced in current 3GPP specifications. These patterns would typically correspond to “guaranteed ABS” and “guaranteed non-ABS”, or more general to guaranteed muted subframes and guaranteed non-muted subframes. These measurements may be used for determining which subframes are unscheduled and may be used for an extended uplink transmission.

According to a second aspect of the invention, there is provided a base station for configuring a user equipment within a cell of a cellular network, wherein the cell comprises the base station, and wherein the base station is configured for serving the user equipment, the base station comprising a transmitting unit for transmitting signals between the base station and the user equipment using a communication channel, wherein the communication channel is divided into subframes, and wherein a part of the subframes being allocated to uplink transmission is unscheduled by the base station due to a predefined muting pattern, and for sending from the base station to the user equipment a signal comprising information about the muting pattern, and a control unit for configuring the user equipment to transmit at unscheduled subframes based on the muting pattern.

The base station may be any type of access point or point of attachment, which is capable of providing a wireless access to a cellular network system. Thereby, the wireless access may be provided for a user equipment or for any other network element, which is capable of communicating in a wireless manner. The base station may be an eNodeB, eNB, home NodeB or HNB, or any other kind of access point.

The base station may comprise a receiving unit, for example a receiver as known by a skilled person. The base station may also comprise a transmitting unit, for example a transmitter. The receiver and the transmitter may be implemented as one single unit, for example as a transceiver. The transceiver or the receiving unit and the transmitting unit may be adapted to communicate with a further base station or the user equipment via an antenna.

The control unit may be implemented as a single unit or may be implemented for example as part of a standard control unit, like a CPU or a microcontroller.

According to a third aspect of the invention, there is provided a user equipment within a cell of a cellular network, wherein the cell comprises a base station, and wherein the user equipment is servable by the base station, the user equipment comprising a transmitting unit for transmitting signals between the base station and the user equipment using a communication channel, wherein the communication channel is divided into subframes, and wherein a part of the subframes being allocated to uplink transmission is unscheduled by the base station due to a predefined muting pattern, a receiving unit for receiving from the base station to the user equipment a signal comprising information about the muting pattern, and a configuration unit for configuring the user equipment to transmit at unscheduled subframes based on the muting pattern.

The user equipment (UE) may be any type of communication end device, which is capable of connecting with the described base station. The UE may be in particular a cellular mobile phone, a Personal Digital Assistant (PDA), a notebook computer, a printer and/or any other movable communication device.

The user equipment may comprise a receiving unit or receiver which is adapted for receiving signals from the base station.

The user equipment may comprise a transmitting unit for transmitting signal for example in the unscheduled subframes. The transmitting unit may be a transmitter as known by a skilled person. The receiver and the transmitting unit may be implemented as one single unit, for example as a transceiver.

The transceiver or the receiver and the transmitting unit may be adapted to communicate with the base station via an antenna.

The configuration unit of the user equipment may be implemented for example as part of a control unit, like a CPU or a microcontroller. Based on signals received by the receiver comprising information about the muting pattern, the configuration unit may configure the user equipment to transmit also in unscheduled subframes. The configuration unit and the receiver may be coupled or may be implemented as one single unit.

According to a fourth aspect of the invention, there is provided a cellular network system, the cellular network system comprising a base station as described above, and a user equipment as described above.

Generally herein, the method and embodiments of the method according to the first aspect may include performing one or more functions described with regard to the second, third or fourth aspect or an embodiment thereof. Vice versa, the base station, user equipment or cellular network system and embodiments thereof according to the second, third and fourth aspect may include units or devices for performing one or more functions described with regard to the first aspect or an embodiment thereof.

According to a fifth aspect of the herein disclosed subject-matter, a computer program for configuring a user equipment, is provided, the computer program being adapted for, when executed by a data processor assembly, controlling the method as set forth in the first aspect or an embodiment thereof.

As used herein, reference to a computer program is intended to be equivalent to a reference to a program element and/or a computer readable medium containing instructions for controlling a computer system to coordinate the performance of the above described method.

The computer program may be implemented as computer readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The herein disclosed subject matter may be realized by means of a computer program respectively software. However, the herein disclosed subject matter may also be realized by means of one or more specific electronic circuits respectively hardware. Furthermore, the herein disclosed subject matter may also be realized in a hybrid form, i.e. in a combination of software modules and hardware modules.

In the above there have been described and in the following there will be described exemplary embodiments of the subject matter disclosed herein with reference to a cellular network system, a base station, a user equipment and a method of configuring a user equipment. It has to be pointed out that of course any combination of features relating to different aspects of the herein disclosed subject matter is also possible. In particular, some embodiments have been described with reference to apparatus type embodiments whereas other embodiments have been described with reference to method type embodiments. However, a person skilled in the art will gather from the above and the following description that, unless other notified, in addition to any combination of features belonging to one aspect also any combination between features relating to different aspects or embodiments, for example even between features of the apparatus type embodiments and features of the method type embodiments is considered to be disclosed with this application.

The aspects and embodiments defined above and further aspects and embodiments of the present invention are apparent from the examples to be described hereinafter and are explained with reference to the drawings, but to which the invention is not limited.

### BRIEF DESCRIPTION OF THE DRAWING

FIG. 1 shows a cellular network system according to an exemplary embodiment of the present invention.

FIG. 2 shows a timing relation between DL transmission of PDCCH and UL transmission of PUSCH.

FIG. 3 shows an exemplary setup of the DL transmission on a normal subframe.

FIG. 4 shows a base station and a user equipment within a cellular network system according to an exemplary embodiment of the invention.

### DETAILED DESCRIPTION

The illustration in the drawing is schematically. It is noted that in different figures, similar or identical elements are provided with the same reference signs.

In the following, embodiments of the herein disclosed subject matter are illustrated with reference to the drawings and reference to aspects of current standards, such as LTE. However, such reference to current standards is only exemplary and should not be considered as limiting the scope of the claims.

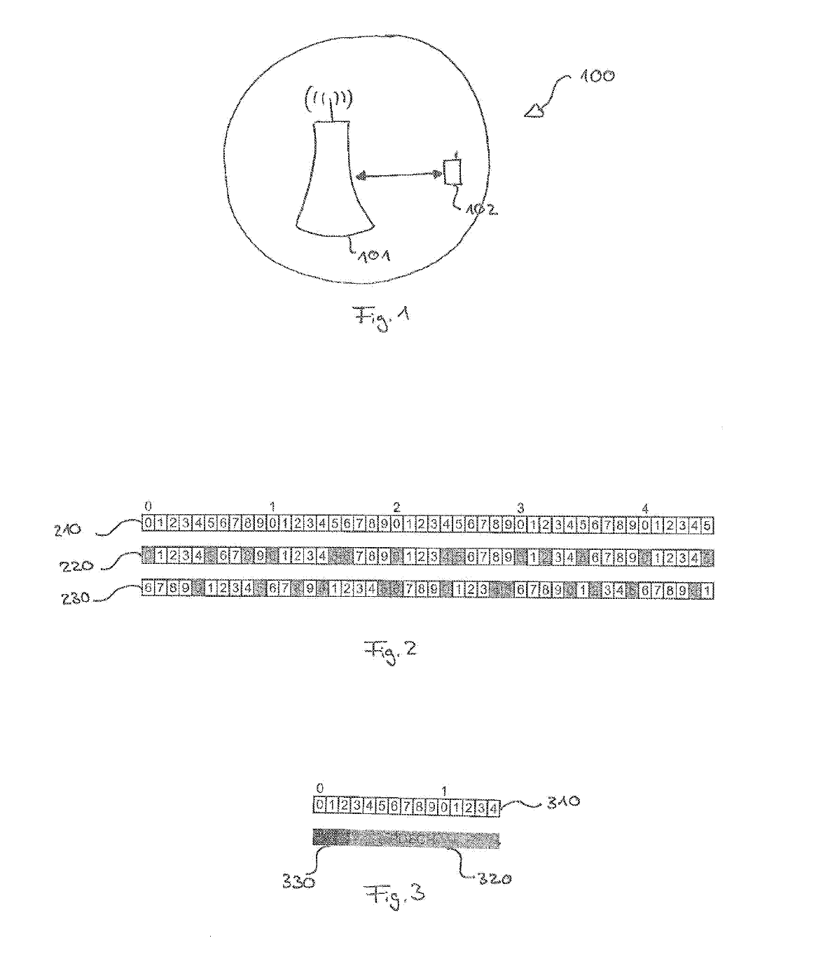

FIG. 1 shows a cell 100 of cellular network system. The cell of the cellular network system comprises a base station 101 and a user equipment 102 being served by the base station.

Signals between the base station and the user equipment are transmittable using a communication channel. The communication channel is divided into subframes, and a part of the subframes being allocated to uplink transmission is unscheduled by the base station due to a predefined muting pattern.

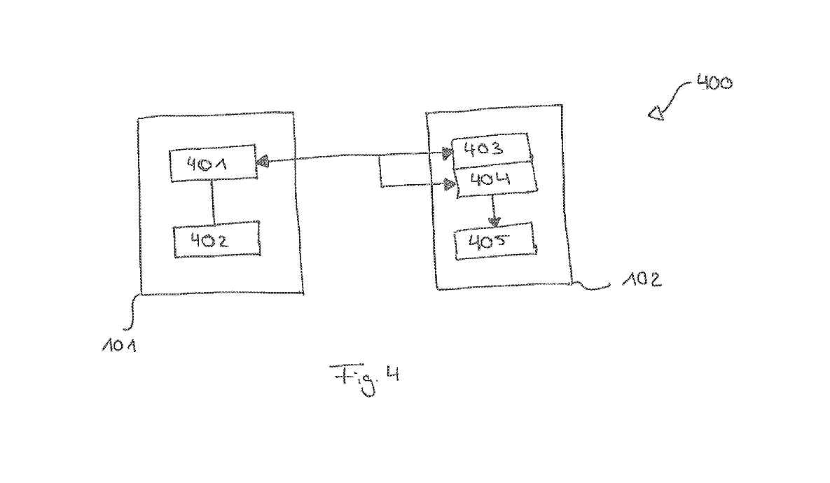

As shown in FIG. 2 illustrating a timing relation between downlink (DL) transmission of PDCCH and uplink (UL) transmission of PUSCH, a downlink TDM muting pattern is applied to the communication channel between the base station and the user equipment for reducing interferences between the cell and a neighboring cell. This means that only essential information is conveyed from the base station. The base station is thus not allowed to transmit any information that is related to the downlink direction within muted subframes. Seen from a downlink scheduling point of view, this is a sensible configuration, as the downlink data channel (physical downlink shared channel—PDSCH) is transmitted within the same transmit time interval (TTI) as the downlink control channel (physical downlink control channel—PDCCH). This is shown in FIG. 2, wherein frames numbered 0, 1 2, 3, 4 are divided into subframes 210. As an example, the subframes of PDCCH 220 are muted with a 30% muting pattern. This means that the subframes 0, 5, 8 of frame 0, the subframes 0, 5, 6 of frame 1, the subframes 0, 4, 5 of frame 2, the subframes 0, 2, 5 of frame 3 and so on are muted, for instance. The associated subframes 230 of the PUSCH are also partly muted. In a normal transmission of OFDM symbols, as shown in FIG. 3, the OFDM symbols of a subframe comprising 14 OFDM symbols (1 ms duration) are allocated to the PDSCH 330 and PDCCH 320.

As uplink data also need scheduling through the PDCCH, there will be a loss of uplink capacity when applying TDM eICIC. There is a fixed timing relationship between the PDCCH transmitted in the downlink and the uplink transmission on the physical uplink shared channel (PUSCH). With this in mind, it is obvious that introducing a muting pattern with for instance 30% of the subframes muted might cause a 30% loss of the downlink capacity as well as a 30% loss of the uplink capacity (on the cell using muting), as illustrated in FIG. 2.

To be able to use also the unscheduled subframes and thus to enhance the uplink capacity or re-capture unscheduled subframes, the base station informs the user equipment about the muting pattern. The user equipment may then be configured to transmit at these unscheduled subframes based on the muting pattern.

The user equipment 102 may be informed in advance about the muting pattern and about an allocation of resources (frequency and/or time domain) within the unscheduled subframes. The user equipment may then, if there is data to be transmitted, transmit within the unscheduled subframes, which would be otherwise empty.

The base station 101 may use signaling for informing the user equipment about the muting pattern. Signaling may be performed by using the radio resource control protocol or the medium access control protocol.

The user equipment may be configured to transmit at unscheduled subframes for a predefined number of subframes and/or during a predefined time period. This configuration may be transmitted to the user equipment by using predefined flags or other signal information.

FIG. 4 shows a cellular network system 400 according to an exemplary embodiment of the invention. The cellular network system comprises a base station 101 and a user equipment 102.

The base station 101 may be any type of access point or point of attachment, which is capable of providing a wireless access to a telecommunication network. Thereby, the wireless access may be provided for a user equipment 102 or for any other network element, which is capable of communicating in a wireless manner.

The base station comprises a receiver as known by a skilled person. The base station may also comprise a transmitter. The receiver and the transmitter may be implemented as one single unit, for example as a transceiver 401 as shown in FIG. 4. The transceiver or the receiving unit and the transmitter may be adapted to communicate with a further base station (not shown) or the user equipment 102 via an antenna.

The base station 101 comprises further a control unit 402. The control unit may be implemented for example as part of a standard control unit, like a CPU or a microcontroller, or may be implemented as a single unit.

The control unit may be adapted to generate signals informing the user equipment about current muting patterns and for generating a configuration signal for configuring the user equipment to transmit within unscheduled subframes. The control unit may be coupled with the transceiver and may be adapted to transmit a signal via the transceiver or transmitter of the base station directly to the user equipment, wherein the signal comprises information about the muting pattern.

The user equipment (UE) 102 may be any type of communication end device, which is capable of connecting with the described base station. The UE may be in particular a cellular mobile phone, a Personal Digital Assistant (PDA), a notebook computer, a printer and/or any other movable communication device.

The user equipment may 102 comprise a transmitting unit 403 for transmitting signals to the base station 101. The user equipment further comprises a receiving unit 404 being adapted to receive signals from the first base. The transmitting unit may be a transmitter as known by a skilled person, and the receiving unit may be a common known receiver. The transmitting unit and the receiving unit may be integrated in one single unit, for example a transceiver. The transceiver or the receiving and the transmitting unit may be adapted to communicate with the base station via an antenna.

The user equipment 102 is served by the base station 101. The user equipment is adapted to receive via the receiver 404 as shown in FIG. 4, a signal from the base station 101, comprising information about the current muting pattern.

The receiver 404 may be coupled to a configuration unit 305. The configuration unit 405 of the user equipment may be implemented for example as part of a control unit, like a CPU or a microcontroller, or may be implemented as a single unit providing the described functionality. The configuration unit is adapted to configure the user equipment 102, based on the information about the muting pattern received by the receiver and provided to the configuration unit.

Based on the muting pattern, the configuration unit configures the user equipment to transmit signals comprising data during uplink transmission subframes also within unscheduled subframes. If there is no data to be transmitted, the configuration unit may configure the user equipment to return to normal operation without transmitting in unscheduled subframes.

Having regard to the subject matter disclosed herein, it should be mentioned that, although some embodiments refer to a “base station”, “eNB”, etc., it should be understood that each of these references is considered to implicitly disclose a respective reference to the general term “network component” or, in still other embodiments, to the term “network access node”. Also other terms which relate to specific standards or specific communication techniques are considered to implicitly disclose the respective general term with the desired functionality.

It should further be noted that a base station as disclosed herein is not limited to dedicated entities as described in some embodiments. Rather, the herein disclosed subject matter may be implemented in various ways in various locations in the communication network while still providing the desired functionality.

According to embodiments of the invention, any suitable entity (e.g. components, units and devices) disclosed herein, e.g. the calculation unit, are at least in part provided in the form of respective computer programs which enable a processor device to provide the functionality of the respective entities as disclosed herein. According to other embodiments, any suitable entity disclosed herein may be provided in hardware. According to other—hybrid—embodiments, some entities may be provided in software while other entities are provided in hardware.

It should be noted that any entity disclosed herein (e.g. components, units and devices) are not limited to a dedicated entity as described in some embodiments. Rather, the herein disclosed subject matter may be implemented in various ways and with various granularity on device level while still providing the desired functionality. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein.

It should be noted that the term “comprising” does not exclude other elements or steps and the “a” or “an” does not exclude a plurality. It may also be possible in further refinements of the invention to combine features from different embodiments described herein above. It should also be noted that reference signs in the claims should not be construed as limiting the scope of the claims.

### LIST OF REFERENCE SIGNS

100 Cell of a cellular network system
101 Base station
102 User equipment
210 Subframe number
220 Muting pattern in PDCCH
230 Associated subframes in PUSCH
310 OFDM symbol number
320 PDCCH symbols
330 PDSCH symbols
400 Cellular network system
401 Transmitting unit of base station
402 Control unit of base station
403 Transmitting unit of user equipment
404 Receiving unit of user equipment
405 Configuration unit of user equipment

1. Method for configuring a user equipment within a cell of a cellular network, wherein the cell comprises a base station, and wherein the user equipment is served by the base station, wherein signals between the base station and the user equipment are transmittable using a communication channel, wherein the communication channel is divided into subframes, and wherein a part of the subframes being allocated to uplink transmission is unscheduled by the base station due to a predefined muting pattern,
the method comprising
sending from the base station to the user equipment a signal comprising information about the muting pattern, and
configuring the user equipment to transmit at unscheduled subframes based on the muting pattern.

2. Method as set forth in claim 1,
wherein configuring the user equipment comprises
sending from the base station to the user equipment a signal comprising information about an allocation of resources within the unscheduled subframes.

3. Method as set forth in claim 2,
wherein the information about the allocation of resources comprises information about the frequency and/or time domain allocation.

4. Method as set forth in claim 1,
wherein sending from the base station to the user equipment a signal comprising information about the muting pattern is based on the radio resource control protocol or the medium access control protocol.

5. Method as set forth in claim 1,
wherein configuring the user equipment comprises
configuring the user equipment to transmit at unscheduled subframes for a predefined number of subframes and/or during a predefined time period.

6. Method as set forth in claim 1, further comprising,
determining whether the user equipment intends to send data during the unscheduled subframes, and
if the user equipment intends to send no data, sending from the user equipment to the base station a signal comprising the information that the user equipment intends to send no data in the unscheduled subframes.

7. Method as set forth in claim 1,
wherein configuring the user equipment comprises performing channel state information measurements by the user equipment, and
wherein configuring the user equipment is based on the channel state information measurements and the muting pattern to transmit at unscheduled subframes.

8. A base station for configuring a user equipment within a cell of a cellular network, wherein the cell comprises the base station, and wherein the base station is configured for serving the user equipment, the base station comprising
a transmitting unit
for transmitting signals between the base station and the user equipment using a communication channel, wherein the communication channel is divided into subframes, and wherein a part of the subframes being allocated to uplink transmission is unscheduled by the base station due to a predefined muting pattern, and
for sending from the base station to the user equipment a signal comprising information about the muting pattern, and
a control unit for configuring the user equipment to transmit at unscheduled subframes based on the muting pattern.

9. A user equipment within a cell of a cellular network, wherein the cell comprises a base station, and wherein the user equipment is servable by the base station, the user equipment comprising
a transmitting unit for transmitting signals between the base station and the user equipment using a communication channel, wherein the communication channel is divided into subframes, and wherein a part of the subframes being allocated to uplink transmission is unscheduled by the base station due to a predefined muting pattern,
a receiving unit for receiving from the base station to the user equipment a signal comprising information about the muting pattern, and
a configuration unit for configuring the user equipment to transmit at unscheduled subframes based on the muting pattern.

10. A cellular network system, the cellular network system, comprising
a base station as set forth in claim 8.

11. A cellular network system, the cellular network system, comprising
a user equipment as set forth in claim 9.
